(19) United States
(12) Patent Application Publication
(10) Pub. No.: US 2022/0176281 A1
(43) Pub. Date: Jun. 9, 2022

(54) METHOD AND SYSTEM FOR AIR FILTRATION

(71) Applicant: Northwestern University, Evanston, IL (US)

(72) Inventors: Kyoo-Chul Park, Wilmette, IL (US); Youhua Jiang, Chicago, IL (US); Christian John Machado, Evanston, IL (US)

(21) Appl. No.: 17/602,175

(22) PCT Filed: Apr. 15, 2020
(86) PCT No.: PCT/US2020/028310

§ 371 Date: Oct. 7, 2021

Related U.S. Application Data
(63) Continuation of application No. PCT/US2019/056463, filed on Oct. 16, 2019.
(60) Provisional application No. 62/833,885, filed on Apr. 15, 2019.

(51) Int. Cl. B01D 39/10; B01D 46/28; F24F 8/117

(52) U.S. Cl. CPC B01D 39/10; B01D 46/28; B01D 2239/0645; B01D 2239/0258; F24F 8/117

(57) ABSTRACT

An airborne particle removal system includes a wire filter having a housing that includes a wall. The wall has an interior surface and an exterior surface. The wire filter also has a plurality of layers of wires mounted to the interior surface of the wall of the housing. Each layer in the plurality of layers includes a plurality of wires designed to collect airborne particles from air and release the airborne particles. The system also includes a receptacle configured to receive the airborne particles released from the plurality of wires.

### CROSS-REFERENCE TO RELATED APPLICATION

The present application claims the priority benefit of U.S. Provisional Patent App. No. 62/833,885 filed on Apr. 15, 2019, the entire disclosure of which is incorporated by reference herein.

### BACKGROUND

Airborne particles, when inhaled, can cause significant health problems in humans. For example, smog is a type of air pollution that significantly affects human health. Many cities in the world suffer from air pollution associated with smog, and medical problems are caused when individuals breathe in airborne microparticles containing heavy metals and chemical composites that are commonly found in smog. The toxicity of microparticles increases when it is combined with other chemical and biological matters such as water and some low surface tension liquids (e.g., nitric acid and other acids) (forming smog) as well as pathogens. In addition to the artificial microparticles, natural microparticles like plant pollens also cause other health-related problems such as allergies. Additionally, liquid droplets in the air can contain germs, viruses, etc.

### SUMMARY

An illustrative airborne particle removal system includes a wire filter having a housing that includes a wall. The wall has an interior surface and an exterior surface. The wire filter also has a plurality of layers of wires mounted to the interior surface of the wall of the housing. Each layer in the plurality of layers includes a plurality of wires designed to collect airborne particles from air and release the airborne particles. The system also includes a receptacle configured to receive the airborne particles released from the plurality of wires.

An illustrative method of forming an airborne particle removal system includes forming a housing of a wire filter, where a wall of the housing has an interior surface and an exterior surface. The method also includes mounting a plurality of layers of wires to the interior surface of the wall of the housing, where each layer in the plurality of layers includes a plurality of wires designed to collect airborne particles from air and release the airborne particles. The method further includes positioning a receptacle such that the receptacle receives the airborne particles released from the plurality of wires.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts an airborne particle removal system in accordance with an illustrative embodiment.

FIG. 2A is a partial cross-sectional view of a wire filter that depicts a mounted wire in accordance with a first illustrative embodiment.

FIG. 2B is a partial cross-sectional view of a wire filter that depicts a mounted wire in accordance with a second illustrative embodiment.

FIG. 2C includes a partial cross-sectional view and a blow-up cross-sectional view of a wire filter in accordance with an illustrative embodiment.

FIG. 3 depicts a table of design parameters for various fog/smog collectors used for testing in accordance with an illustrative embodiment.

FIG. 4 depicts the bending of wires of systematically varied elastic moduli and under various wind speeds in accordance with an illustrative embodiment.

FIG. 5A is a last image of a collected droplet prior to release (or detachment) from a wire mounted at 27° relative to a wall of the housing of a wire filter in accordance with an illustrative embodiment.

FIG. 5B is a last image of a collected droplet prior to release from a wire mounted at 58° relative to a wall of the housing of a wire filter in accordance with an illustrative embodiment.

FIG. 5C is a last image of a collected droplet prior to release from a wire mounted at 76° relative to a wall of the housing of a wire filter in accordance with an illustrative embodiment

FIG. 5D depicts the measured onset time (t_{first}) plotted with respect to inclination angle of wires with various diameters in accordance with an illustrative embodiment.

FIG. 6A is a plot of measured fog collection rate (\dot{V}_{c}) according to Equation 8 with respect to the predicted fog collection rate

$$( {η}_{ac} \cdot \frac{St}{St + \frac{π}{2}} )$$

for airborne particle removal systems having design parameters specified in FIG. 3 in accordance with an illustrative embodiment.

FIG. 6B is a plot of the measured

$${\dot{V}}_{c} \cdot \frac{St + \frac{π}{2}}{St}$$

with respect to the predicted η_{ac} to investigate the effects of design parameters to η_{ac} in accordance with an illustrative embodiment.

FIG. 6C depicts the number of wires per layer plotted with respect to number of layers in accordance with an illustrative embodiment.

FIG. 7A is a plan view of an airborne particle removal system with a plurality of airborne particle collection tubes in accordance with a first illustrative embodiment.

FIG. 7B is a plan view of an airborne particle removal system with a plurality of airborne particle collection tubes in accordance with a second illustrative embodiment.

### DETAILED DESCRIPTION

Current state-of-the-art air cleaning technology utilizes mesh filters to collect particles within the air. These systems are fundamentally limited because the filters get clogged due to aggregated microparticles, which results in a filter replacement cycle of less than 1 week in some instances (depending on the air pollution level) and added maintenance costs, in addition to the energy costs involved with running the system. Described herein are systems and methods for improving air quality that avoids the problem of rapidly clogging filters and the associated increased maintenance costs to replace them.

In an illustrative embodiment, the proposed system uses wires, which may be flexible, to efficiently collect airborne particles and remove them from the air. As used herein, airborne particles can refer to any combination of chemical particles, biological particles, pathogens, germs, viruses, natural microparticles such as pollen, water, etc. that are present in the air. Through experimentation, it has been determined that wires with smaller diameters lead to better fog/smog collection efficiency per unit area. In this document, the terms ‘smog’ and ‘fog’ are used interchangeably. Moreover, the bending of flexible wires can facilitate the transport of collected smog particles using an air drag force and/or gravity so that the clogging issue can be prevented. Similarly, vibration of the flexible wires in combination with air flow (e.g., wind) can also help to transport the collected airborne particles off the wires so that they do not become clogged. Additionally, the modification of surface properties such as texturing the surfaces with nanostructures can provide additional useful functionalities such as self-cleaning and anti-bio/chemical fouling of the wires while they are operating in a harsh environment.

The systems described herein can be used to collect airborne particles created from factory processes, which will enhance protection of the environment. Also, using the proposed system within closed environments such as hospitals, cars, trains, airplanes, livestock farms, greenhouses, etc. can effectively prevent the airborne dissemination of diseases that typically spread through the air (e.g., common cold, influenza, SARS, MERS, Covid-19, etc.). The methods and systems described herein can also be used for a variety of other applications, including chemical processing plants, fuel processing/distillation towers, environmental pollution reduction, indoor air quality control (including cars, airplanes, and hospitals), portable outdoor personal filters, etc. The proposed methods and systems are also valuable for enhancing energy efficiency associated with phase change heat transfer in chemical plants and buildings, reducing environmental pollution, and controlling indoor air quality.

Effective filtration of airborne particles from the air is an extremely valuable technique for improving the environment and air quality. However, as discussed above, traditional air filtration systems are inefficient in collecting particles due in part to filter clogging and other design issues. The systems and methods described herein are based on experiments conducted with various arrangements of solid structures to improve airborne particle collection efficiency and to avoid clogging of the solid structures with the collected particles. For some of these experiments, the system includes different layers of inclined wires with varying quantities and diameters that are packed into a tube (housing) and used to investigate the effects of solid structure arrangement on airborne particle collection efficiency. These experiments provide a proven basis that guides the design of airborne particle filters, as described herein. While the total surface areas of wires are fixed, wires with smaller diameters and packed into more layers lead to higher smog collection efficiency. Moreover, in at least some embodiments, flexible wires are used because the bending of flexible wires facilitates the transport of collected airborne particles so that the wires do not clog (i.e., become saturated with airborne particles such that further particulate collection is reduced or eliminated). The conducted experiments also studied the optimal shape of wires and the corresponding elastic modulus that leads to the fastest transport. These experiments are described in more detail below.

### Motivation and Design Parameters

A first objective of the inventors was to investigate how the arrangement of solid structures affect the airborne particle collection efficiency. When the liquid loss during transport is neglected, the collection rate (\dot{V}_{c}) is proportional to the aerodynamic collection efficiency (η_{ac}) and deposition efficiency (η_{d}), as:

\dot{V}_{c}∝η_{ac}·η_{d}. Equation 1

The aerodynamic collection efficiency (η_{ac}) describes the interaction between the collection system and the particle-laden flow (i.e., fog, smog, etc.). The aerodynamic collection efficiency can be approximated as a function of the solid fraction facing normal to the flow (referred to as shade coefficient, SC), the pressure drop coefficient of the system (Cₒ), and the drag coefficient for an impermeable plate (C_{d}), as follows:

$${η}_{a c} \approx \frac{s c}{1 + \sqrt{\frac{{c}_{o}}{{c}_{d}}}} , \qquad Equation 2$$

and Cₒ can be also approximated as a function of shade coefficient (SC), as:

$${C}_{o} \approx [ 1.3 S C + {( \frac{SC}{1 - SC} )}^{2} ] , \qquad Equation 3$$

where C_{d} can be considered as the numerical constant which has secondary effects on η_{ac} as compared with SC and Cₒ.

Both the denominator (Cₒ) and numerator (SC) are a function of SC, and therefore there exists a SC that leads to a largest η_{ac}. Experimental results indicate that using a single layer of mesh, the largest η_{ac} is around 0.2 when SC is around 0.55. Such an η_{ac} of around 0.2 is low, which means a significant portion of airborne droplets cannot be collected or filtered. Moreover, the captured liquid can clog the collector/filter so that the actual collection efficiency is significantly lower, especially on the currently commercialized mesh-like collectors. These results therefore indicate that modifications of collectors are needed to improve the η_{ac} and overcome the clogging issue, and the proposed system is designed to remedy these issues.

Based on the experimental results, some implementations of the proposed system include individually aligned, flexible wires in contrast to the commonly used meshes. The commonly used meshes are horizontally mounted, rigid, and interconnected. Using such meshes, the transport of the collected liquid/particles is made difficult, and severe clogging issues occur in such configurations. By contrast, the bending of flexible wires under gravity and air-drag force (when present) help facilitate the transport of liquid/particles such that the flexible wires do not become clogged with particles, inefficient, or unusable. In alternative embodiments, rigid wires may be used in the proposed system, and the rigid wires can be mounted at an angle to help facilitate liquid/particle transport.

It was also found that the speed of liquid/particle transport along the wires depends on the extent of bending, which essentially depends on the elastic modulus of the wires used. Therefore, inclined wires were tested at various angles relative to a wall, and an optimal inclination that leads to the fastest liquid transport was identified, as discussed herein. By matching the shape of the bent wire with the optimal inclination, the elastic modulus of the wire under specific wind speeds was determined.

In some embodiments, wires having the optimal inclination are mounted at different layers along a tube, which is different from the single-layer mesh approach used in traditional systems. There are two area fractions of solid structures (shade coefficient, SC). One is denoted as SCₜₒₜₐₗ, which represents the total area fraction of solids that are facing the incoming flow, the other is denoted as SC_{local} (SC_{local}=SCₜₒₜₐₗ/Layers, where Layers represents the number of layers), which represents the area fraction of solids per layer. Thus, Equations 2 and 3 can be re-written, respectively, as:

$$\begin{matrix}{η}_{a c} \approx \frac{{SC}_{total}}{1 + \sqrt{\frac{{C}_{o}}{{C}_{d}}}} , and & Equation 4 \\ {C}_{o} \approx [ 1.3 S {C}_{ι o c a l} + {( \frac{{SC}_{local}}{1 - {SC}_{local}} )}^{2} ] . & Equation 5\end{matrix}$$

It can be seen that when the numerator in Equation 4, SCₜₒₜₐₗ, is maintained as a constant, the denominator in Equation 4 can be decreased by decreasing Cₒ. This is possible by decreasing SC_{local} via having multiple layers of wires, as shown in Equation 5. Therefore, the collection efficiency η_{ac} can be increased by using multiple layers of wires.

### Examples

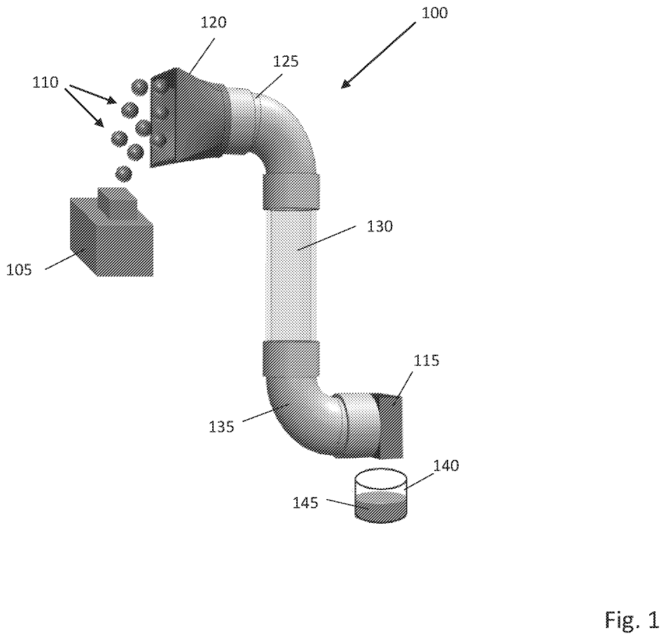

FIG. 1 depicts an airborne particle removal system 100 in accordance with an illustrative embodiment. The system of FIG. 1 includes a humidifier 105 that is used to generate smog 110 that is received by the airborne particle removal system 100, and a fan 115 that is used to draw the smog 110 through the airborne particle removal system 100. In some applications, the humidifier 105 and/or the fan 115 may not be included in the system. The airborne particle removal system 100 includes an inlet port 120 that receives air (e.g., the smog 110), a first elbow 125 mounted to the inlet port 120 and a proximal end of a wire filter 130, a second elbow 135 mounted a distal end of the wire filter 130 and the fan 115, and a receptacle 140 to collect the airborne particles which are removed from the air. As used herein, ‘proximal’ refers to the direction towards the inlet port end of the airborne particle removal system 100 and ‘distal’ refers to the direction towards the receptacle 140 of the airborne particle removal system 100.

In an illustrative embodiment, the inlet port 120 has a tapered shape in which a circumference of a proximal end of the inlet port 120 is larger than a circumference of a distal end of the inlet port 120. Alternatively, the circumference of the proximal end can be the same as the circumference of the distal end of the inlet port 120. In some embodiments, the proximal end of the inlet port 120 can have a profile of a first shape (e.g., a square, rectangle, circle, oval, triangle, etc.) and the distal end of the inlet port 120 can have a profile of a second shape (e.g., a square, rectangle, circle, oval, triangle, etc.). In alternative embodiments, the profiles of the proximal and distal ends of the inlet port 120 can have the same shape and/or size. In some embodiments, the proximal and distal ends of the inlet port 120 can have the same shape, but different sizes. In the embodiment of FIG. 1, the distal end of the inlet port 120 has a profile that is circular in shape such that the distal end of the inlet port 120 mates with and mounts to a proximal end of the first elbow 125.

The inlet port 120 directs the air to be cleaned into the first elbow 125. A distal end of the first elbow 125 mates with and mounts to a proximal end of the wire filter 130. As shown, the first elbow 125 transitions the air flow from horizontal (i.e., substantially parallel to a ground/floor surface) to vertical (i.e., substantially perpendicular to the ground/floor surface). As discussed in more detail below, this configuration allows gravity to act upon collected particles such that they collect in the receptacle 140. In the orientation of the embodiment of FIG. 1, the air flows in a vertical downward direction through the wire filter 130 at an angle of approximately 90° relative to the ground/floor surface. In alternative implementations, the air can flow in a vertical upward direction through the wire filter 130. Additionally, regardless of whether air flows in an upward or downward direction, the orientation of the wire filter 130 can be at any angle between 0-360° relative to the ground/floor surface.

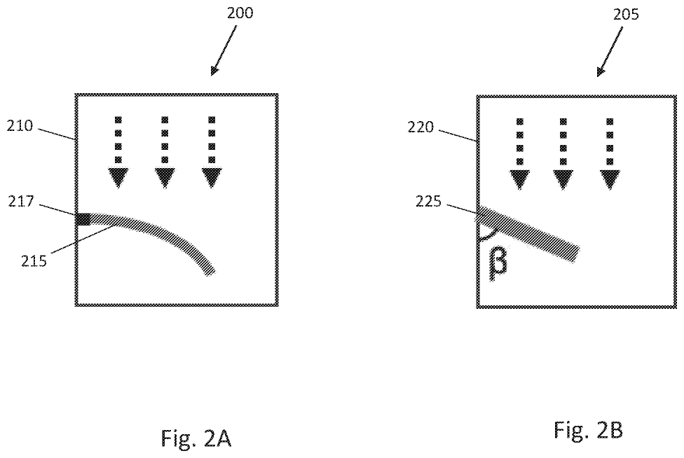

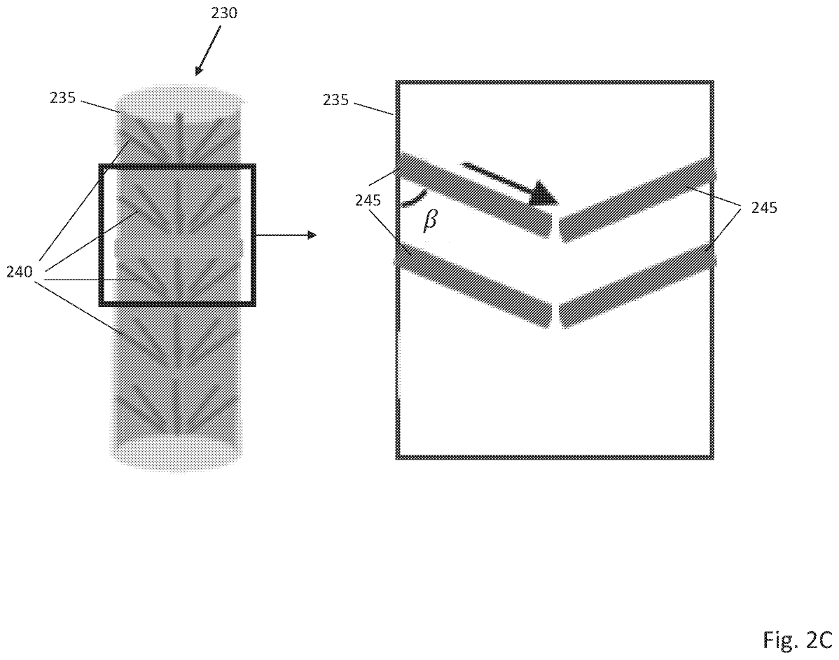

The wire filter 130 includes a housing and a plurality of layers of wires mounted within the housing. The plurality of layers of wires are designed to collect airborne particles from the air as the air passes through the wire filter 130. Each of the wires is mounted to an interior surface of the housing of the wire filter 130. The wires can be mounted to the housing using a weld, solder, adhesive, clip, fastener, etc. In some embodiments, the wires are detachable from the housing such that they can be replaced. In such an embodiment, the wires can attach to the housing via a removable fastener, a friction fit male/female connection (e.g., peg and hole, loop and hook, etc.), a magnetic connection, etc. The wires are described in more detail in FIG. 2. As shown in FIG. 1, the wire filter 130 has a cylindrical shape (circular cross-section). In alternative embodiments, the wire filter 130 can have a different shape and/or cross-section (e.g., square, rectangle, triangle, oval, irregular, etc.). In another alternative embodiment, in addition to the wire filter 130, the inlet port 120, the first elbow 125, and/or the second elbow 135 can include layers of wires mounted to the interior surfaces thereof and designed to collect particles from the air.

A distal end of the wire filter 130 mates with and mounts to a proximal end of the second elbow 135. In an illustrative embodiment, gravity and/or air flow causes collected particles 145 to move from the wire filter 130 into the second elbow 135, from which they are directed into the receptacle 140. The fan 115 is mounted at the distal end of the second elbow 135. In alternative embodiments, the fan 115 may not be used. In such implementations, wind and other natural phenomenon can be used to direct air into and through the system. In alternative embodiments, the humidifier 105, the inlet port 120, the first elbow 125, the second elbow 135, and/or the fan 115 may not be included in the airborne particle removal system 100. In such embodiments, a proximal end of the wire filter can act as the inlet port and the distal end of the wire filter can be directly or indirectly mounted to the receptacle such that collected particles are deposited therein. In other embodiments, the receptacle 140 may not be included.

In an illustrative embodiment, the receptacle 140 can be an enclosed container (i.e., not exposed to the environment) that is designed store accumulated collected particles. The receptacle 140 can be mounted directly or indirectly (i.e., using a duct or other conduit) to the distal end of the second elbow 135 in some embodiments. In one embodiment, the receptacle 140 can include an access panel (e.g., a hinged door, removable panel, plugged hole, drain, etc.) that allows collected particles to be removed therefrom. Alternatively, the receptacle 140 may include a port connected to a vacuum hose that is used to vacuum the collected particles out of the receptacle 140 such that it does not exceed its collection capacity.

FIG. 2A is a partial cross-sectional view of a wire filter 200 that depicts a mounted wire in accordance with a first illustrative embodiment. FIG. 2B is a partial cross-sectional view of a wire filter 205 that depicts a mounted wire in accordance with a second illustrative embodiment. FIG. 2C includes a partial cross-sectional view and a blow-up cross-sectional view of a wire filter in accordance with an illustrative embodiment. In FIGS. 2A and 2B, the arrows with dashed lines depict the direction of air flow through the system.

The wire filter 200 of FIG. 2A includes a housing 210, and a wire 215 is mounted to an interior side of a wall of the housing 210. The wire 215 is curved such that a distal end of the wire 215 (i.e., the end not mounted to the wall of the housing 210) has a lower elevation than a proximal end (i.e., the end mounted to the wall of the housing 210) of the wire 215. The curve in the wire 215 facilitates the movement of collected particles along the wire 215 in a direction that travels from the proximal end toward the distal end of the wire 215. As discussed herein, the wire 215 can be flexible and curve in the wire 215 can be due to gravity and air flow as particles accumulate thereon. Alternatively, the wire 215 may be rigid and formed into the curved shape. As a result, the collected particles accumulate at the end of the wire 215 until their combined mass releases from the end and moves toward the receptacle of the system.

In an illustrative embodiment, all of the wire 215 or at least a portion of the wire 215 can be flexible such that the curvature of the wire 215 changes as airborne particles accumulate thereon. For example, the wire 215 can be made of a semi-flexible material such as a metal, rubber, plastic, polymeric, etc. In some embodiments, only a portion of the wire 215 is flexible. For example, a distal ½ (or ⅓, ¼, ⅕, etc.) of the wire 215 may be flexible and the remainder may be rigid. In another alternative embodiment, the wire 215 may be rigid (in either a curved or straight configuration) and adjustable such that a user can remotely or directly adjust an angle of the wire 215 relative to the wall of the housing 210. The wire 215 can have a circular cross-sectional profile in one embodiment. Alternatively, the cross-sectional profile of the wire 215 can be an inverted V, a square, a rectangle, a triangle, an oval, etc.

The wire 215 can be mounted to the housing 210 using a weld, solder, adhesive, clip, fastener, hinge, friction fit (e.g., a cup mounted to the wall and designed to receive the wire 215), etc. The wire 215 can be permanently or detachably mounted to the housing 210 depending on the implementation. In one embodiment, an actuator or manual control can be used to adjust an angle of the wire 215. For example, an actuator 217 can be optionally mounted to the wire 215 such that movement of the actuator 217 moves the angle of the wire 215 relative to the wall of the housing 210. The actuator 217 can also be used to vibrate or shake the wire 215 to facilitate more rapid release of the collected particles from the wire 215. The actuator 217 can be remotely controlled through a wired or wireless connection. In the case of wireless control, the actuator 217 can include a transceiver to receive the control signal from the remote location. The actuator 217 can also include a power source (e.g., battery), processor, memory, and/or other components to control movement of the wire 215. In an alternative embodiment, an actuator can be used to move the entire system such that all of the wires within the wire filter are moved/vibrated simultaneously.

Alternatively, the wire 215 may be manually adjustable. For example, an extension can extend through the wall of the housing 210 such that a user can manipulate the angle of the wire 215 relative to the wall of the housing 210 by manipulating the extension. The extension can be a portion of the wire, or a lever, handle, or other control mounted to the proximal end of the wire 215. In such an embodiment, the wire 215 can be mounted to the wall of the housing 210 such that the wire 215 pivots relative to the wall. As such, moving the extension in a downward direction would cause the distal end of the wire 215 to rise in elevation and moving the extension in an upward direction would cause the distal end of the wire 215 to drop in elevation (assuming the wire filter 205 is mounted vertically as depicted).

The wire filter 205 of FIG. 2B includes a housing 220 and a wire 225 mounted to an interior side of a wall of the housing 220. The wire 225 is straight and mounted at an angle β such that a distal end of the wire 225 (i.e., the end not mounted to the wall of the housing 220) has a lower elevation than a proximal end (i.e., the end mounted to the wall of the housing 220) of the wire 225. The angle at which the wire 225 is mounted facilitates the movement of collected particles along the wire 225 in a direction that travels from the proximal end toward the distal end of the wire 225. As a result, the collected particles accumulate at the end of the wire 225 until their combined mass releases from the end and moves toward the receptacle of the system. In an illustrative embodiment, the angle β can be any angle between 0-90°.

In some embodiments, at least a portion of the wire 225 can be flexible such that the wire 225 changes from straight to curved as airborne particles are collected thereon. For example, the wire 225 can be made of a semi-flexible material such as a metal, rubber, plastic, etc. In some embodiments, only a portion of the wire 225 is flexible. For example, a distal ½ (or ⅓, ¼, ⅕, etc.) of the wire 225 may be flexible and the remainder may be rigid. In one embodiment, the wire 225 may be adjustable such that a user can remotely or directly adjust an angle of the wire 225 relative to the wall of the housing 220. The angle of the wire 225 can be adjusted using any of the techniques described herein. Similarly, the wire 225 can be mounted to the housing 210 using any of the techniques described herein.

The left portion of FIG. 2C shows a wire filter 230 in accordance with an illustrative embodiment. As shown, the wire filter 230 includes a housing 235 and 5 layers 240 of wires mounted to the interior wall of the housing 235. Alternatively, a different number of layers may be used such as 1, 2, 3, 10, 25, 50, 100, 1000, etc. Additionally, each of the layers can include 1, 2, 3, 5, 10, 25, 50, 100, etc. wires. In one embodiment, the wires in each layer can be mounted at an equal distance apart from one another in a circle within the housing 235 (i.e., such that a line connecting the mounting locations of the wires on the housing is a circle). Alternatively, the wires of each layer can be mounted offset from one another (e.g., such that a series of lines connecting the mounting locations of the wires on the housing 235 form a sawtooth wave). Alternatively, the wires can be positioned randomly or in a pattern about the interior wall of the housing 235. For example, one pattern can position all of the wires in the housing 235 such that they are equidistant from one another. In the embodiment of the FIG. 2C, the housing 235 is transparent. In alternative embodiments, the housing 235 may be opaque or translucent.

The right portion of FIG. 2C depicts a close-up view of wires 245 mounted to the housing 235 at an angle β relative to the wall of the housing 235. In an illustrative embodiment, the distal tips of the wires 245 do not contact one another within the interior of the housing 235. However, in some alternative embodiments, the distal tips of the wires 245 may be in partial contact with one another such that an opening is formed at each layer through which the collected particles travel as they release from the distal ends of the wires 245 due to air forces, gravity, coating(s) on the wires 245, vibration or other movement of the wires 245, etc. The arrow in FIG. 2C depicts a direction of flow of collected particles.

### Experiments

A system similar to that depicted in FIG. 1 was used to conduct experiments with respect to improving efficiency of the system. The test system included a humidifier (nebulizer) that was used to generate fog and smog droplets. The radii of fog and smog droplets was approximately 5 micrometers (um). The fog was made by pure water, and smog was made by pure water mixed with silicon dioxide (SiO₂) nanoparticles. Specifically, SiO₂ with diameters in the range from 20 to 40 nanometers (nm) was dispensed into deionized water to prepare a solution containing 1% SiO₂ in weight. The produced airborne droplets entered the airborne particle removal system and the wind speeds (0.5, 1.0, 2.0, and 3.0 meters/second (m/s)) were controlled by a fan attached to the end of the system. Because the weight concentration of silicon dioxide was very low (1%), the aerodynamic properties of the smog (e.g., density) droplets were considered to be close to those of fog droplets. Therefore, various experiments (e.g., bending of flexible wires, speed of liquid transport, and airborne droplet collection rate) were conducted using fog droplets.

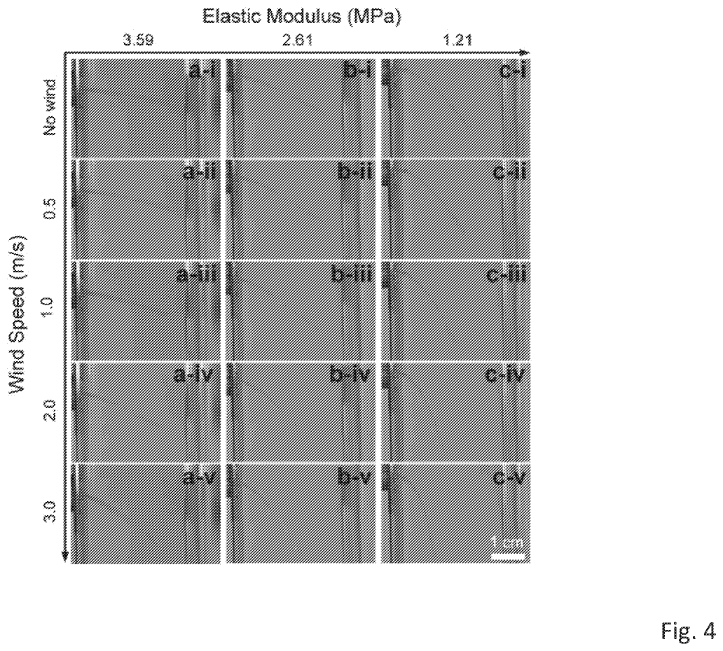

To explore the effect of wire elasticity to liquid transport, flexible wires with ˜4 centimeter (cm) in length and 1 millimeter (mm) in diameter were prepared using Polydimethylsiloxane (PDMS) with different base/curing agent mass ratios. The base/curing agent ratios were 5:1, 10:1, and 16.7:1, resulting in elastic moduli of 3.59, 2.61, and 1.21 megapascals (MPa), respectively. The flexible wires were horizontally mounted inside of a tube housing. The shape of the bent flexible wires was recorded by a camera and the maximum bending is depicted herein with reference to FIG. 4.

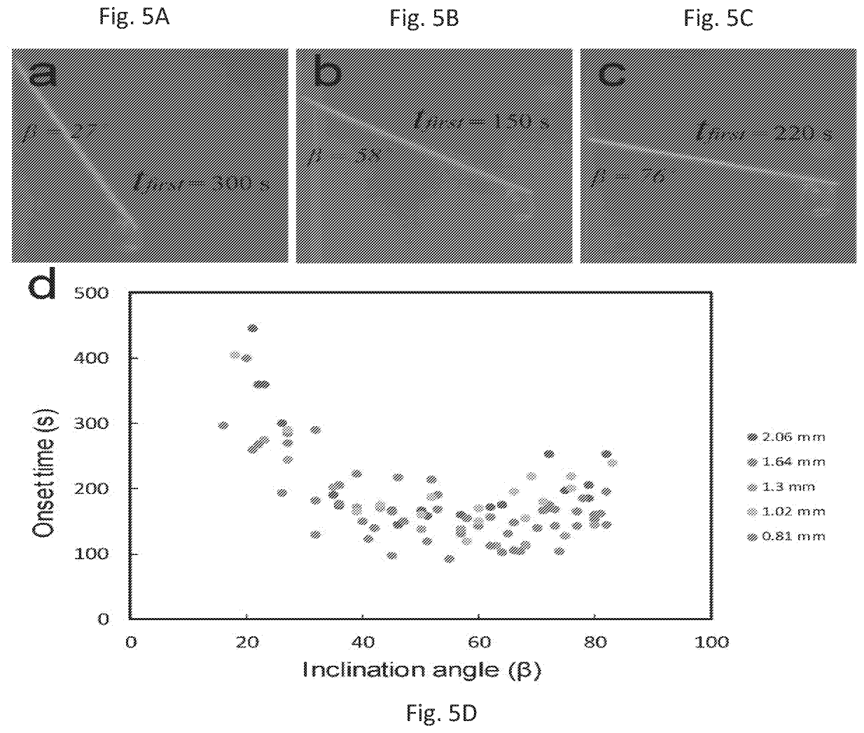

To explore the effect of wire inclination to the speed of liquid transport, rigid, superhydrophilic wires of ˜4 cm in length were used. The wire inclination (angle) with the wall, β, varied from 10° to 80° and various wire diameters were used (0.81, 1.02, 1.30, 1.63, and 2.06 mm). Alternatively, different lengths (e.g., 1 mm, 5 mm, 2 cm, 5 cm, 10 cm, 20 cm, 100 cm, etc.), angles (e.g., 0-90°), and/or diameters (e.g., 1 micron-10 mm) may be used. The speed of liquid transport in fog collection can be quantified as the time taken to observe the first detachment of the liquid droplet from the wire, denoted as onset time (t_{first}). The shorter onset time represents the faster liquid transport. As shown in FIG. 5D (discussed below), the shortest onset time occurred at the wire inclination angle of ˜60°, regardless of wire diameter. Therefore, in the following experiments, the wires were inclined at an angle relative to wall of ˜60°.

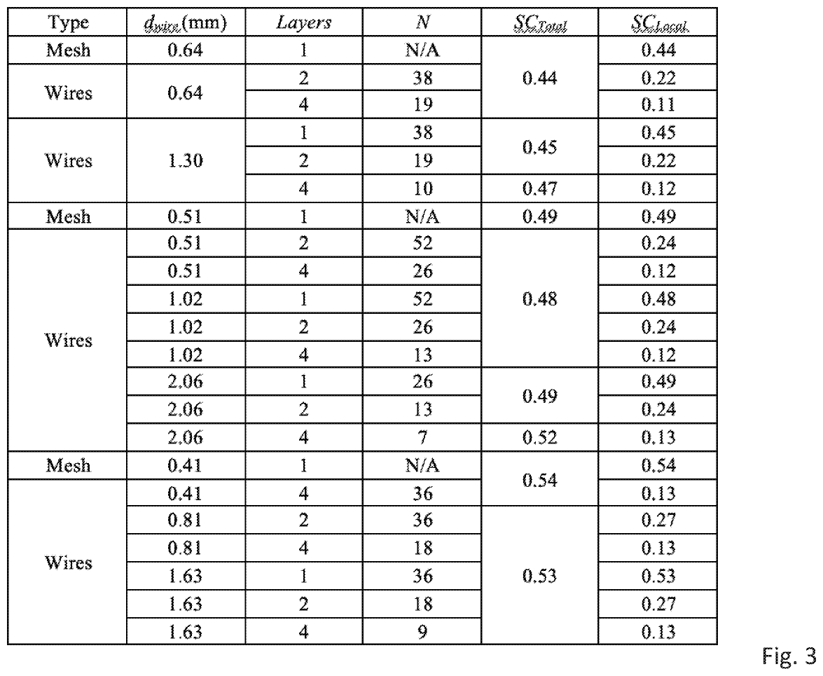

Wires with lengths of ˜4 cm were packed inside of the transparent tube (inner diameter of 7 cm) to collect droplets. As noted above, all of the wires were inclined at an angle relative to the wall of ˜60°. Therefore, the length of wire perpendicular to the incoming flow was ˜3.5 cm. The collected liquid on the wires eventually dipped down and flowed into a reservoir (or receptacle) of the system. Horizontally mounted meshes with three different diameters (0.41, 0.51, and 0.64 mm) and corresponding shade coefficients (0.54, 0.49, 0.44) were also tested. Wires with eight different diameters (0.41, 0.51, 0.64, 0.81, 1.02, 1.30, 1.63, and 2.06) were mounted at different layers (1, 2, and 4). The number of wires was adjusted to match the shade coefficient of the meshes. The distance between adjacent layers was 2 cm. The specific design parameters, including total (SCₜₒₜₐₗ) and local (SC_{local}) shade coefficient, wire diameters (d_{wire}), number of layers (Layers), and number of wires per layers (N) are shown in FIG. 3. Specifically, FIG. 3 depicts a table of design parameters for various fog/smog collectors used for testing in accordance with an illustrative embodiment. Conducted experiments lasted for 30 minutes and the weight of the collected liquid in the reservoir (which was regarded to be equivalent to the liquid collected by the solid wires) was measured by a microbalance.

FIG. 4 depicts the bending of wires of systematically varied elastic moduli and under various wind speeds in accordance with an illustrative embodiment. Wire diameters were fixed at ˜1 mm. As shown in FIG. 4, the horizontally placed (flexible) wires were bent under gravity and wind speeds as particles accumulated on them. The amount of bending becomes more significant at higher wind speeds and smaller elastic modulus, and the extent of bending of the wire corresponds to the wire elastic modulus at the specific wind speed. The time taken for the first detachment (i.e., release) of the collected liquid that results from the gravitational forces and the air-drag forces acting on the wires and the solid-liquid adhesion force, is referred to as the onset time, t_{first}. With respect to onset time, t_{first}, it was found that a smaller inclination angle (β) results in a shorter t_{first} because a larger portion of gravitational force and air-drag force can be used to transport liquid. On the other hand, the collection rate of the liquid is proportional to the area of the inclined wire that is perpendicular to the incoming air flow and a larger collection rate leads to a shorter t_{first}. Therefore, from the perspective of collection rate, a larger inclination angle (β) results in a shorter t_{first}. This contrast of analysis from different perspectives indicate that there exists an optimal inclination (bending) of the wires that leads to the fastest liquid transport (the shortest t_{first}).

In order to find out the optimal state of bending, superhydrophilic wires with various inclination angles with the wall of the housing were examined. A portion of this experiment is depicted in FIG. 5. Specifically, FIG. 5A is a last image of a collected droplet prior to release (or detachment) from a wire mounted at 27° relative to a wall of the housing of a wire filter in accordance with an illustrative embodiment. FIG. 5B is a last image of a collected droplet prior to release from a wire mounted at 58° relative to a wall of the housing of a wire filter in accordance with an illustrative embodiment. FIG. 5C is a last image of a collected droplet prior to release from a wire mounted at 76° relative to a wall of the housing of a wire filter in accordance with an illustrative embodiment. In FIGS. 5A-5C, the wire diameter is 1.02 mm and the wind speed was set at 0.5 m/s. FIG. 5D depicts the measured onset time (t_{first}) plotted with respect to inclination angle of wires with various diameters in accordance with an illustrative embodiment.

FIG. 5D indicates that the optimal inclination angle which leads to the shortest t_{first} is approximately 60°, regardless of the variation in wire diameter. Comparing the bending of flexible wires shown in FIG. 4, the wire with elastic modulus of 2.61 MPa under the wind speed of 0.5 m/s shows the inclination angle of about 60°. Therefore, the elastic modulus of 2.61 MPa can be selected for the airborne droplets collector under a wind speed of 0.5 m/s to allow for the fastest liquid transport. These experiments can be repeated for different wind speeds (e.g., 1.0, 2.0, 3.0, 5.0, etc. m/s) to provide a comprehensive guideline for the selection of wire elastic modulus for the fastest particle transport. In alternative embodiments, a different elastic modulus (e.g. 1 MPa, 2 MPa, 5 MPa, etc.) and/or a different inclination angle (e.g., 5°, 20°, 45°, 72°, 85°, etc.) can be used.

Building on the fact the wire inclination of 60° showed the fastest liquid transport, airborne droplet collectors/filters with inclination angles of 60° were prepared and tested. Using actual fog droplets (r_{fog}≈5 μm) and individual solid wires (e.g., 0.33 to 2.06 mm) showed that η_{d} can be approximated as:

$${η}_{d} = \frac{St}{St + \frac{π}{2}} , \qquad Equation 6$$

where St represents the Stokes number, given as:

$$S t = \frac{4 {ρ}_{water} {r}_{fog}^{2} {v}_{o}}{9 {μ}_{air} {d}_{wire}} , \qquad Equation 7$$

where ρ_{liquid}, r_{fog}, μₐᵢᵣ, vₒ, and d_{wire} represent the liquid density (it should change corresponding to the properties of fog/smog droplets), radius of fog/smog droplets, air viscosity, wind flow speed, and wire diameter, respectively. Combining Equations (1) and (6), one would expect the following relation:

$${\dot{V}}_{c} ∝ {η}_{a c} \cdot \frac{St}{St + \frac{π}{2}} . \qquad Equation 8$$

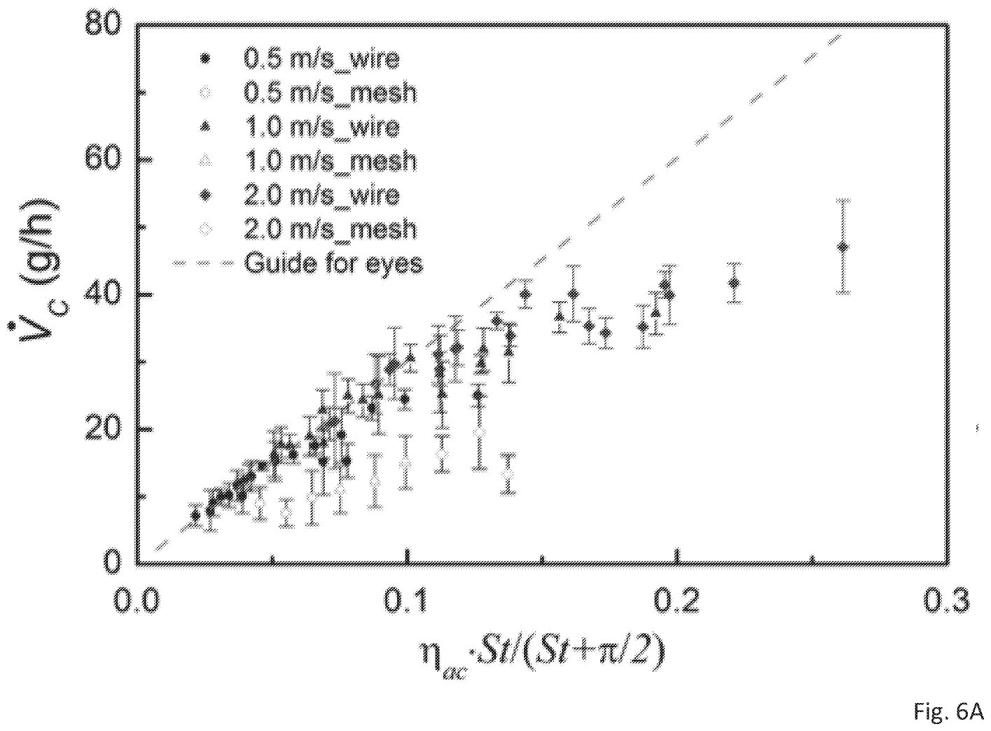

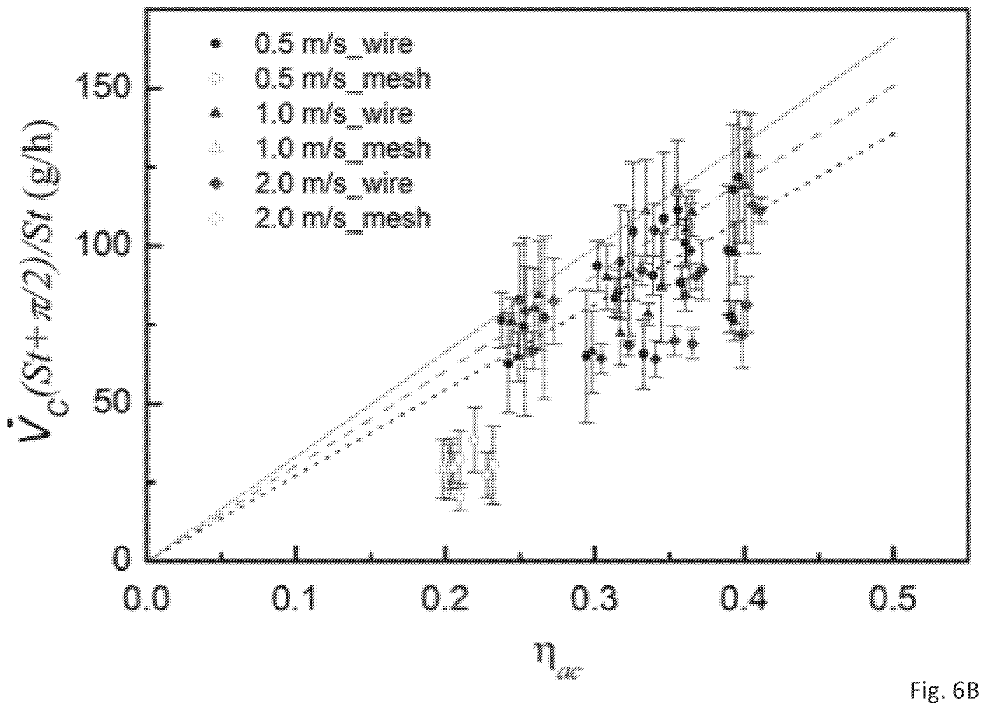

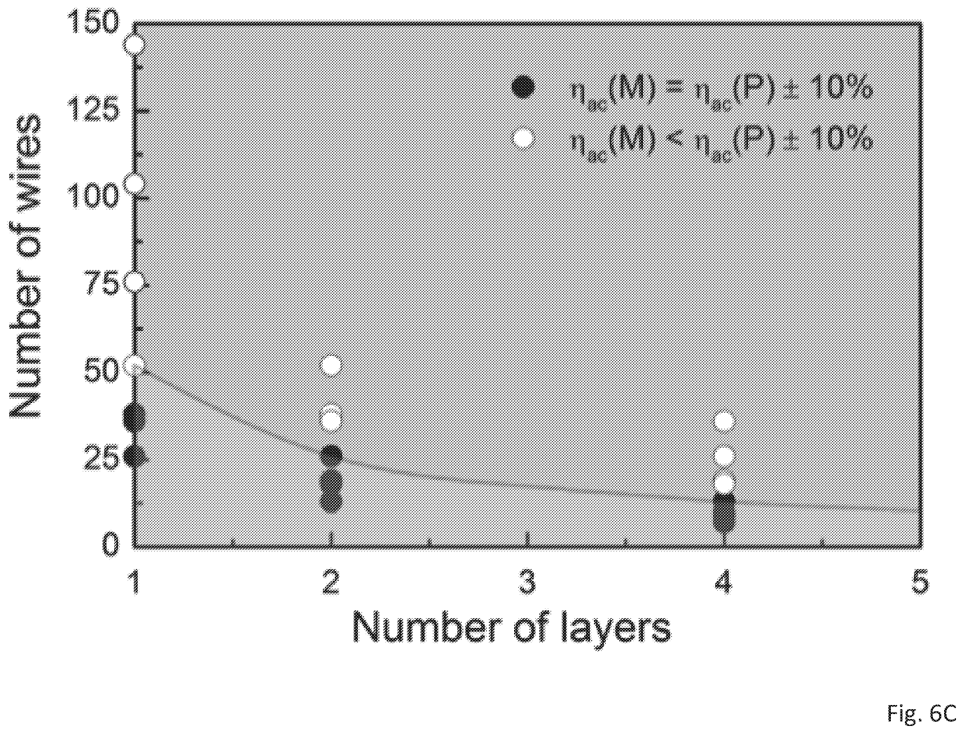

FIG. 6A is a plot of measured fog collection rate (\dot{V}_{c}) according to Equation 8 with respect to the predicted fog collection rate

$$( {η}_{a c} \cdot \frac{St}{St + \frac{π}{2}} )$$

for airborne particle removal systems having design parameters specified in FIG. 3 in accordance with an illustrative embodiment. For the fog collectors made with individual wires (filled symbols), when

$${η}_{a c} \cdot \frac{St}{St + \frac{π}{2}}$$

is less than 0.15, a clear linear relationship (denoted by the dashed line) between the measured \dot{V}_{c} and the predicted one can be detected. Fog collectors made with a single-layer mesh (hollow symbols) collected much less liquid than those made with individual wires, although the shade coefficient is similar. For example, the wires with 0.51 mm in diameter mounted at four layers (26 wires per layer) collected 200% more liquid than the corresponding single-layer mesh with the same shade coefficient. Moreover, a smaller wire diameter leads to a larger collection efficiency.

The clogging issue due to poor liquid transport is regarded as the major reason leading to the deterioration of the fog collection performance using a single-layer mesh. When

$${η}_{a c} \cdot \frac{St}{St + \frac{π}{2}}$$

is more than 0.15, the measured \dot{V}_{c} reached a plateau and cannot increase with the increase in the prediction. It was speculated that this deviation is mainly related to η_{ac} rather than the deposition efficiency,

$$St / ( St + \frac{π}{2} ) ,$$

especially for wires packed at multiple wires. Therefore,

$$St / ( St + \frac{π}{2} )$$

is considered to remain unchanged and an investigation of η_{ac} was conducted. It was found that re-arranging Equation (8) as

$${\dot{V}}_{c} \cdot \frac{St + \frac{π}{2}}{St}$$

can be regarded as the measured aerodynamic collection efficiency.

FIG. 6B is a plot of the measured

$${\dot{V}}_{c} \cdot \frac{St + \frac{π}{2}}{St}$$

with respect to the predicted η_{ac} to investigate the effects of design parameters to η_{ac} in accordance with an illustrative embodiment. More specifically, FIG. 6B shows measured fog collection rate divided by deposition efficiency

$$( St / St + \frac{π}{2} )$$

plotted with respect to the aerodynamic collection efficiency (η_{ac}). As shown, a clear linear relationship for the date points in between the solid line and the black-dotted line can be detected, where the solid and the black-dotted lines represent the ±10% deviation from the linear line (dashed line). The data points below the lines represent the under-performed fog collectors, including the collectors made with single-layer mesh and the individual wires that are packed at multiple layers.

FIG. 6C depicts the number of wires per layer plotted with respect to number of layers in accordance with an illustrative embodiment. Thus, a regime map is presented in FIG. 6C to investigate how the design parameters (e.g., number of wires per layer and the number of layers) affect the fog collection rate. The black-filled symbols in the lower regime represent the fog collectors (various layers and numbers of wires per layer) that fall near the linear line in FIG. 6B (the data points in between the solid and black-dotted lines). The hollow symbols in the upper regime represent the under-performed fog collectors in FIG. 6B (the data points below the black-dotted line). A clear distinction between two regimes can be detected. For one layer of individual wires, the maximum number of wires is 52, above which the actual aerodynamic collection efficiency is less than the predicted efficiency. For two and four layers of wires, the maximum number of wires is 36 and 19, respectively. The short distance (2 cm) between the adjacent layers is speculated to be the reason that leads to the decrease of the maximum number of wires per layer with the increase in the number of layers. First, the fog stream is perturbed by the former layer of wires so that the fog collection efficiency of the latter layer cannot be accurately described by Equations (4) and (5). Second, the objective of multiple layers of wires is to reduce the pressure drop coefficient of the system (Cₒ). However, the short distance between layers may not completely reduce the pressure drop. Third, the content of fog-laden flow may decrease significantly after passing through the first layer of wires. Therefore, the fog collection efficiency of the following layers decreases due to the insufficiency of fog droplets. In alternative embodiments, different configurations, sizes, etc. may be used.

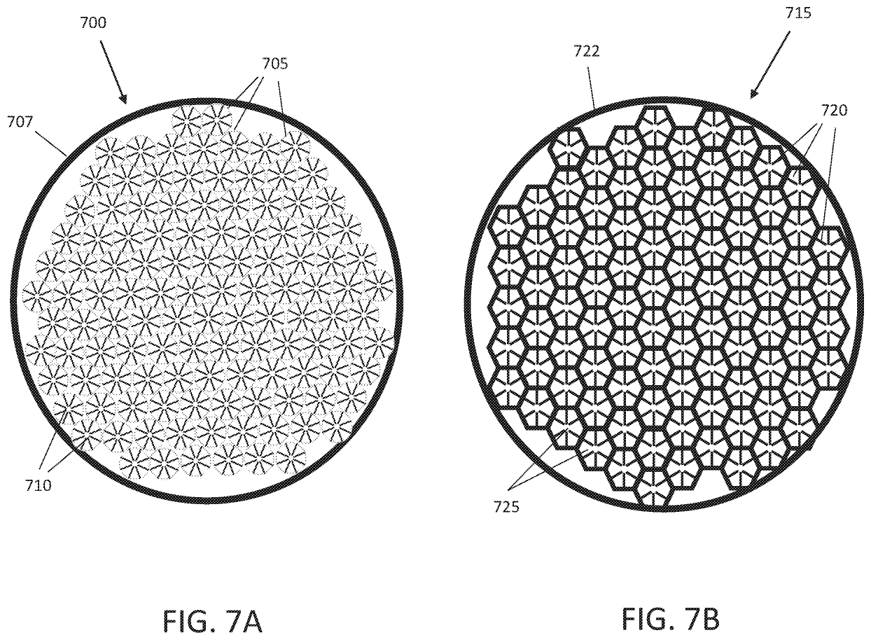

In one embodiment, the airborne particle removal system includes a plurality of tubes (or individual housings) that are formed within a main housing. Each of the plurality of tubes includes a plurality of layers of wires that are used to collect airborne particles from air that passes through the main housing. FIG. 7A is a plan view of an airborne particle removal system 700 with a plurality of airborne particle collection tubes 705 in accordance with a first illustrative embodiment. As shown, the airborne particle collection tubes 705 are circular in shape and are positioned within a main housing 707. Each of the tubes 705 includes a plurality of layers of wires 710 (only one layer is visible in each tube in the view of FIG. 7A). FIG. 7B is a plan view of an airborne particle removal system 715 with a plurality of airborne particle collection tubes 720 in accordance with a second illustrative embodiment. As shown, the airborne particle collection tubes 720 are hexagonal in shape to form a honeycomb pattern, and are positioned within a main housing 722. Each of the tubes 720 includes a plurality of layers of wires 725 (only one layer is visible in each tube in the view of FIG. 7B). In alternative embodiments, different shapes may be used for the individual tubes and/or the main housing, such as square, rectangular, triangular, etc. In other alternative embodiments, the main housing may not be included, and the system can be formed via interconnection of the individual tubes (e.g., via a weld, adhesive, integrals structure, etc.). The individual tubes and wires of FIGS. 7A and 7B can include any of the features described herein (e.g., the wires can be flexible, coated, mounted at an angle, etc.), and can operate in accordance with the principles described herein.

Thus, described herein are airborne particle removal systems and methods to design such systems to efficiently capture airborne particles. Currently, the commercially available collectors suffer from low collection efficiency, mainly because (1) the remaining liquid on the solid structures blocked the system permeability (clogging issues) and (2) the arrangement of solid structures are not designed with high aerodynamic collection efficiency. To address the first problem, individually aligned, flexible wires are used to enhance the transport of the captured liquid to avoid the clogging issues. Flexible wires can bend under gravity and a wind flow, and it was found that the inclination angle of a wire with the wall at ˜60° gives the fastest liquid transport (shortest time taken to allow a detachment of a droplet from a wire). The experiments described herein also visualized the bending of wires with various elastic modulus under various wind speeds. This visualization provides a guideline for choosing the appropriate wire elasticity to achieve the wire inclination of ˜60° under a given wind speed.

The second problem can be solved by reducing the pressure drop coefficient of the collector/filter, via distributing the wires from one layer onto multiple layers. Specifically, individually aligned, inclined (˜60°), superhydrophilic wires with various wire diameters were mounted within a tube at various layers (see detailed design parameters in FIG. 3) to improve the aerodynamic collection efficiency. As compared to the single-layer mesh, although the total shade coefficient and the wire diameter remain the same, the individually aligned, inclined (˜60°), superhydrophilic wires mounted at multiple layers significantly increased the collection rate (up to ˜200% increase).

The housing used to form the systems described herein can be formed from a plastic, metal, rubber, or other material. Similarly, the wires can be made from plastic, rubber, metal, etc. In some embodiments, the wires are made from used aluminum or Polydimethylsiloxane (PDMS). The specific wettability of the wires can be determined by considering the higher or optimal adhesion strength between the liquid droplets and the wires. The wires can be coated with a hydrophilic coating or a superhydrophilic coating in some embodiments to facilitate particle collection. The wires can also be coated with an oleophilic coating or a superoleophilic coating in some embodiments to facilitate particle collection. In some embodiments, the wires are decorated with functional particles such as nanoparticles that help facilitate the collection and/or release of particles. Additionally, coupling the flexible wires with nanostructures can be used to help the wires resist bio/chemical fouling in various harsh environments.

In one embodiment, a computing system can be used to perform any of the operations described herein to generate a design for an optimal wire filter based on filter size, wind speed, application, etc. The computing system can include a processor, memory, user interface, and transceiver. The memory can store the operations described herein as computer-readable instructions. The processor can access the computer-readable instructions from the memory and execute them to perform the operations such that a wire filter design is generated. Data and preferences can be input through the user interface by a user, and the transceiver is used for communication with other local and remote computing systems.

Although the embodiments described herein have referenced filtration of air, it is to be understood that the proposed methods and systems are not so limited. The proposed methods and systems can similarly be used to remove particles from other types of gases such as natural gas, propane, methane gas, etc.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. An airborne particle removal system comprising:
a wire filter that includes:
a housing that includes a wall, wherein the wall has an interior surface and an exterior surface; and
a plurality of layers of wires mounted to the interior surface of the wall of the housing, wherein each layer in the plurality of layers includes a plurality of wires designed to collect airborne particles from air and release the airborne particles; and
a receptacle configured to receive the airborne particles released from the plurality of wires.

2. The system of claim 1, wherein the plurality of wires is mounted at an inclination angle relative to the interior surface of the wall, wherein the inclination angle is between 0-90°.

3. The system of claim 2, wherein the inclination angle comprises 60°.

4. The system of claim 1, wherein the plurality of wires is flexible such that a curvature of a given wire changes as the airborne particles collect thereon.

5. The system of claim 1, wherein each of the plurality of the wires is individually mounted to the interior surface of the wall.

6. The system of claim 1, wherein the plurality of wires has a superhydrophilic coating.

7. The system of claim 1, further comprising a fan configured to move the air past the plurality of layers of wires.

8. The system of claim 1, further comprising a humidifier configured to humidify the air before the air enters the wire filter such that the airborne particles are more likely to collect on the plurality of wires.

9. The system of claim 1, further comprising an inlet port directly or indirectly mounted to a proximal end of the wire filter.

10. The system of claim 9, wherein the inlet port includes a proximal end and a distal end, wherein the proximal end has a larger circumference than the distal end, and wherein the distal end mounts to the wire filter.

11. The system of claim 1, wherein the plurality of wires is detachable from interior surface of the wall.

12. (canceled)

13. The system of claim 1, further comprising an actuator configured to move one or more of the plurality of wires.

14. The system of claim 1, further comprising nanoparticles placed onto the plurality of wires to facilitate release of the collected airborne particles.

15. The system of claim 1, wherein a first layer of wires in the plurality of layers includes first wires mounted in a circular pattern on the interior surface of the wall of the housing.

16. The system of claim 1, wherein a given wire in the plurality of wires includes a first portion and a second portion, wherein the first portion is rigid and the second portion is flexible.

17. The system of claim 1, wherein the housing comprises a main housing, and wherein the system further comprises a plurality of tubes positioned within the main housing, wherein each tube in the plurality of tubes includes a plurality of layers of wires.

18. A method of forming an airborne particle removal system, the method comprising:
forming a housing of a wire filter, wherein a wall of the housing has an interior surface and an exterior surface;
mounting a plurality of layers of wires to the interior surface of the wall of the housing, wherein each layer in the plurality of layers includes a plurality of wires designed to collect airborne particles from air and release the airborne particles; and
positioning a receptacle such that the receptacle receives the airborne particles released from the plurality of wires.

19. The method of claim 18, further comprising mounting a distal end of an inlet port directly or indirectly to a proximal end of the wire filter, wherein a proximal end of the inlet port has a larger circumference than the distal end of the inlet port.

20. The method of claim 18, further comprising mounting an actuator to the housing, wherein the actuator is configured to move one or more of the plurality of wires.

21. The method of claim 18, further comprising placing nanoparticles onto the plurality of wires to facilitate release of the collected airborne particles.
